(19) United States
(12) Patent Application Publication
(10) Pub. No.: US 2006/0274314 A1
(43) Pub. Date: Dec. 7, 2006

(54) EXAMINATION SYSTEM FOR EXAMINATION OF A SPECIMEN; SUB-UNITS AND UNITS THEREFORE, A SENSOR AND A MICROSCOPE

(76) Inventors: Peter THOMSEN, Kgs. Lyngby (DK); Thomas NIKOLAJSEN, Slangerup (DK); Sergey I. BOZHEVOLNYI, Aalborg Øst (DK); Mads Hoy SORENSEN, Frederiksberg (DK)

Correspondence Address: BUCHANAN, INGERSOLL & ROONEY PC, POST OFFICE BOX 1404, ALEXANDRIA, VA, 22313-1404, US

(21) Appl. No.: 11/420,777

(22) Filed: May 29, 2006

Related U.S. Application Data
(63) Continuation-in-part of application No. PCT/DK04/00830, filed on Nov. 29, 2004.

(30) Foreign Application Priority Data
Nov. 28, 2003 (DK) PA 2003 01764

(51) Int. Cl. G01N 21/55

(52) U.S. Cl. 356/445

(57) ABSTRACT

An evanescent field microscopy sub-unit for an examination system for examination of a specimen, the evanescent field microscopy sub-unit includes a first dielectric cladding layer having an absolute refractive index n₁, and a core layer having a thickness tₘ, a width wm and a length Iₘ coated onto at least a part of said first cladding layer, the evanescent field microscopy sub unit being arranged to support a specimen to form a part or all of a second cladding on the side of the core layer opposite the first cladding layer.

### TECHNICAL FIELD

The present invention relates to an examination system for examination of a specimen, sub-units therefore a sensor and a microscope, the sub-units include an evanescent field microscopy sub-unit, a surface plasmon polarition unit, and a set of surface plasmon sub-units. The invention also comprises an examination system in combination with a specimen.

The invention deals in particular with systems an parts of systems for examination of specimens, and in particular samples of biological origin, such as specimens of human, animal, vegetable and microorganism.

### BACKGROUND ART

Systems for examination of specimens such as biological specimens are well known in the art. In 1873 Ernest Abbe founded light microscopy and demonstrated that diffraction of light by the specimen and by the objective lens determined image resolution. Since then the need for systems providing higher resolutions, simpler and less expensive user interface and broader scope of application has increased rapidly. In particular, there has been focus on developing microscopy techniques that could contribute to an understanding of the structure and ultra structure of fixed dead cells. Furthermore, the endocytic pathway, other intracellular membrane transport systems and the cytoskeleton with associated motor proteins are very dynamical features of the living cell. For this reason each topic as well as developments in microscopic imaging technologies has been subject to intense research. Presently the challenge is to achieve a better understanding of the dynamical, living cell in 4 dimensions (X, Y, Z and time) under non-invasive conditions.

Today translocations of fluorescent molecules in the cell are studied in cellular assays in the pharmaceutical industry. Outer membrane regions of mammalian cells are often the main focus because a main part of drug targets are present in this region. Thus studies of cellular processes such as vesicle docking, fusion and signaling may depend on evanescent wave techniques such as total internal reflection fluorescence microscopy (TIR-FM). Such techniques are based on illumination of fluorophores in a thin optical plane right above the cover slip. When using such techniques the observations are, however, limited to a very thin plane which is typically about 0.1 μm. A TIR-FM microscope is e.g. described in “Lighting up the cell surface with evanescent wave microscopy” by Derek Toomre and Dietmar J. Manstein, Trends in cell biology. Vol. 11 No. 7 July 2001. The fluorophores in the membrane of the cell under investigation are excited via interaction with an evanescent wave propagating along an interface between two materials. The evanescent wave is excited by light incident on the interface from the high refractive index side at an angle of incidence larger than the critical angle of total internal reflection. The penetration depth of the evanescent tail into the low refractive index material depends on the refractive index difference between the two media and the angle of incidence. Typically, however, it is of the order of 50-200 nm. As no light is transmitted through the interface, only the evanescent field interacts with the fluorophores making it possible to observe fluorescence from a cross-section from the surface to a few hundred nm into the cell.

Another examination system is disclosed in “Imaging of cell/substrate contacts of living cells with surface plasmon resonance microscopy” by K. F. Giebel et. al. Biophysical Journal. Volume 76. pp 509-516. January 1999. This system, described as a surface plasmon microscope (SPM), includes a thin layer of metal placed on a dielectric substrate onto which the specimen is placed. The SPM consists of two arms carrying the optical components for illuminating and imagining the base of a glass prism. The glass prism is coated with a thin layer of metal (Al) to allow optical excitation of surface plasmons. The angle between the two arms can be adjusted to obtain the condition for the occurrence of plasmon resonance. The penetration depth of the evanescent tail into the specimen in this system is also very low, such as up to 230 nm.

Very often the events of interest in a specimen e.g. a living cell extend further into the Z-plane. No technique today is capable of solving this problem with sufficient resolution.

### OBJECTS AND SUMMARY

It is an objective of the invention to provide a technology which extends the reach of evanescent wave fluorescence microscopy further into a specimen under examination and thereby makes it possible to provide a large scope of applications e.g. including observation of dynamics within a cell not previously accessible by evanescent wave techniques. This objective has been achieved by the invention as it is defined by the claims.

The embodiments of the present invention disclosed provide a device for evanescent wave fluorescence microscopy, which include thin-film optical waveguide structures which support the propagation of electromagnetic modes with a modal field distribution allowing for efficient excitation via end-fire coupling from an optical fiber.

Particularly the invention relates to a surface plasmon polaritions guiding structure where the core of the waveguide preferably is formed by a metallic thin film embedded in an essentially symmetric dielectric environment. The surface plasmon polarition mode is confined to the metal dielectric interface leading to a significant field enhancement compared with prior art TIR surface mode. In addition the thin metal film may provide a guiding structure with maximum field amplitude of the evanescent tails.

A special feature of the examination device of the invention is that the substance under investigation constitutes parts of the cladding of the guide in such a way as to facilitate interaction between the analytes, while other parts of the cladding is formed by a solid material index matched to the substance under investigation. In addition to the ease of generating strong evanescent fields, the invention in one embodiment relates to wave guiding structures where the penetration depth of the field into the substance can be varied from a few hundred nanometers up to several micrometers to facilitate scanning evanescent microscopy.

The present invention deals in one embodiment with thin high index waveguides which are characterized by essentially symmetric distribution of the refractive index of the cladding surrounding the core. Specifically the invention deals in one embodiment with a configuration where the index of the substrate is similar to that of water (n=1.331).

In one embodiment of the invention the cut-off thickness of the core of the guide approaches zero. A consequence of this is that the film thickness can be made very thin and still provide efficient guiding. The penetration depth of the evanescent fields in this configuration may be highly dependent on the film thickness and can be varied from hundreds of manometers to several microns by varying the film thickness from a couple of hundred nanometers down to about 50 nm. Also, the penetration depth may be highly sensitive to the symmetry condition of the refractive indices of the cladding. Small deviations, of the order of 0.01, may result in variation of the penetration depths from a few hundred nanometers to several microns. This effect can in the present invention be used to dynamic varying the penetration depth of the evanescent field into the substance under investigation.”

The examination system provided by the invention uses in a preferred embodiment the principle of generating long range surface plasmon polaritions (LR-SPP) along a thin metal film. Such states are characterized by large penetration depth of the evanescent fields and by relatively low propagation losses. In addition to the increase in penetration depth into the specimen it is also possible to examine a relatively large area (width×length) at a time.

In one embodiment of the invention the examination system is used in combination with a conventional microscope.

Basically the embodiments of the examination system of the invention comprise an evanescent field microscopy sub-unit for examining a specimen e.g. by generating the plasmons.

In one embodiment the evanescent field microscopy sub-unit is in the form of a dielectric core-cladding sub-unit which comprises a core layer which includes a dielectric material with a refractive index substantially higher than that of the dielectric cladding, such as n_{core}−n_{cladding}>0.01 such as >0.1. The dielectric material of the dielectric core-cladding sub-unit may in principle be any type of material fulfilling the refractive index requirement e.g. one or more of glass materials, polymer materials and semiconductor materials.

In other embodiment the evanescent field microscopy sub-unit is a surface plasmon polarition sub-unit, i.e. the evanescent field microscopy sub-unit is a surface plasmon polaritions guiding structure where the core of the waveguide is formed by a metallic thin film embedded in an essentially symmetric dielectric environment.

In the following the term ‘evanescent field microscopy’ encompasses the term ‘surface plasmon polarition’, wherein a surface plasmon polarition structure is an evanescent field microscopy structure.

In the following the evanescent field microscopy sub-unit and applications is in particular described in the form of the surface plasmon polarition sub-unit. However it should be understood that the surface plasmon polarition sub-unit may be replaced with a dielectric core-cladding sub-unit in situations where the core layer may include a dielectric material with a refractive index substantially higher than that of the dielectric cladding.

The evanescent field microscopy sub-unit may be an integrated part of the examination system or it may be a separate part which can be used in the examination system.

The invention thus comprises an evanescent field microscopy sub-unit for an examination system for examination of a specimen. The evanescent field microscopy sub-unit preferably comprises a first dielectric cladding layer with an absolute refractive index n₁, and a core layer having a thickness tₘ, a width wₘ and a length Iₘ coated onto at least a part of the first cladding layer.

In one embodiment the first dielectric cladding layer may be omitted, or it may be extremely thin e.g. up to 20 nm. In these embodiment is preferred that the core layer or the thin first dielectric cladding is supported by a support unit, e.g. a Si wafer, a glass plate, a polymer plate a metal plate or similar. This embodiment may include all the features disclosed in the following but feature of the first dielectric cladding layer if it does not comprise such first dielectric cladding layer.

By the term absolute refractive index is meant the index of refraction of a substance when the ray passes into it from a vacuum.

The evanescent field microscopy sub-unit is arranged to support a specimen to form a part or all of a second cladding on the side of the core layer opposite the first cladding layer.

The evanescent field microscopy sub-unit is preferably arranged to propagate waves along its length when a second cladding or a remaining part of a second cladding is placed on the side of the core layer opposite the first cladding layer and thereby to generate plasmons.

The core layer may be of any material having a negative real part dielectric constant when excited by an electromagnetic wave at longer optical wavelength, such as longer than 50 nm, and preferably wavelength in the infrared, far infrared, visible and ultraviolet ranges, such as from 50 nm to 10000 nm, e.g. from 100 nm to 100 nm, such as from 200 nm to 2000 nm, such as from 400 nm to 1200 nm. In one embodiment, the core layer is of a material having a negative real part dielectric constant when subjected to waves having a frequency of f₁ in the core material, wherein f1 preferably is in the interval from 1,5*10¹⁴ Hz (2000 nm) to 1,5*10¹⁵ Hz (200 nm).

In principle the core material may be any metal. Preferred metals include gold, silver, copper, aluminum, platinum, nickel, chromium, cadmium, indium, titanium, lead, mixtures thereof and alloys thereof.

In one embodiment, the core layer includes superconducting materials. In this embodiment, the core layer preferably has a negative real part dielectric constant at a temperature where the superconducting material is superconducting when subjected to waves f₁ between 1.5*10¹⁴ Hz and 1.5*10¹⁵ Hz.

The core layer should preferably be relatively thin, namely sufficiently thin to support the propagation of a plasmonic mode bound to the core/cladding interface with an evanescent tail penetrating into the cladding when sandwiched between to equal claddings and the core is fed with light. In one embodiment, the core has a thickness tₘ of up to about 100 nm, such as between 1 nm and 100 nm, such as between 1 nm and 50 nm, such as between 1 and 15 nm, such as 10-50 nm. The thickness of the core may be equal in length or width, but it may in one embodiment vary.

In one embodiment, the core layer has a thickness tₘ which is varying about 10% or less over the extension of the layer defined by the width wₘ and the length Iₘ, such as about 5% or less, about 3% or less, preferably the core layer has essentially uniform thickness over the extension of the layer: The term essentially implies that any minor variation cannot be detected by using the evanescent field microscopy sub-unit.

In one embodiment, the core layer has a thickness tₘ which is varying about 10% or more over the extension of the layer, such a 20% or more, such as 30% or more, the variation may be continuous or stepwise along the extension of the core, such as along its length Iₘ and/or along its width wₘ.

In one embodiment, the core layer has a thickness tₘ which is varying in waves along its width so as to form 2 or more thin layer channels where plasmon can be generated whereas the intermediate thicker channels do not provide for the generation of plasmons. In this embodiment it is preferred that the face of the core opposite the first cladding is relatively plane e.g. sufficiently plane to support a sample. The thin layer channels may have equal or different thickness. In one embodiment where the thin layer channels have different thickness, the penetration depth of the evanescent tail of the generated plasmons may differ from each other to thereby provide for an examination in varying depth of a specimen.

In one embodiment the metal surface may be modulated in such a way as to provide a nanostructured metallic surface. Electromagnetic waves propagating along, either the sensing surface or an eventual feeding core excites localized plasmons in the nanoparticles. The confinement of energy in such nanostructures results in very strong electromagnetic fields in close proximity of the structures. Such fields are found to very efficient for exciting fluorochromes. Further the presence of nanostructures or arrays of nanostructures can be used to alter the radioactive properties of the fluoroschromes either by increasing or decreasing the photonic density of states available for radioactive decay. Further information about nana-structuring of metallic surface and its effects can be found in the overview article: Lakowitcz, Analytical biochemistry vol. 298 pages1-24.

The core layer may in principle have any width; however, since the light will diverge in width direction, the width of the core should be correlated to the feeding of the light in order to have a sufficient light concentration. In one embodiment, the core layer has a width wm of at least its thickness, preferably a width wm of 0.1 mm or more such as between 1 and 20 mm, such as between 5 and 10 mm. In one embodiment, the first cladding layer extends beyond the width of the core layer, in particular if the width is small relative to the amount of light fed to the core, preferably to cover the edge to avoid loss of light.

In one embodiment, the core has a first smaller width close in the end from where the light is to propagate from, followed by a wider section placed beneath or above the area supposed to support a specimen. This area beneath or above the area supposed to support a specimen will in the following be denoted the examination area.

The examination area will preferably have a size of at least 1 mm², more preferably at least 10 mm², such as between 1 mm² and 2 cm². In one embodiment the examination is 1×1 cm².

The length of the core may in principle be unlimited, but the propagation length of the light along the core may be relatively limited e.g. to about 30 mm or less e.g. about 20 mm or less or even 10 mm or less, unless additional light is fed to the core along its length e.g. using a feeding core as will be described in more details below.

The core may in principle have any shape, provided that the plasmon polarition sub-unit can support a specimen to be sufficiently close to the core layer to be exposed to the evanescent plasmon waves. In one embodiment, the core layer is in the form of a strip which is straight, curved, bent or tapered.

In one embodiment, the core/cladding layers are formed as a tube arranged to comprise a specimen in the tube, the specimen may e.g. flow through the tube or it may be contained in the tube during the examination.

The dielectric material of the cladding layer should preferably have a positive real part dielectric constant when subjected to waves having a frequency of f₂ in the core material, wherein f₂ preferably is between 1.5*10¹⁴ Hz and 1.5*10¹⁵ Hz. In general any non-conducting materials may be used, in particular materials which are at least partially transparent.

In one embodiment, the first dielectric cladding layer has an absolute refractive index n₁ of at least 1.20, such as up to about 2.0, the absolute refractive index n1 is preferably in the interval from 1.30 to 1.40, such as around 1.32-1.34, such as about 1.33. By selecting the first cladding material with such refractive index, the ability of generating plasmons with high penetration depth is high, since the specimen to be examined in most situations will have a similar refractive index.

In one embodiment the penetration depth of the evanescent field into the cladding can be varied by changing the thickness of the metal film, or by creating a slight mismatch in refractive index of the lower cladding layer and the substance under investigation. Such a mismatch can be introduced e.g. via thermo-optical, electro-optical, magneto-optical or nonlinear optical effects. Furthermore stress introduced in the lower cladding and physically changing the material composition of the buffer or lower cladding material can be used to introduce the change. By using either of these effects a device can be realized for scanning the penetration depth of the evanescent field into the substance under investigation.

The first dielectric cladding layer may in one embodiment comprise two or more regions e.g. layered regions. In one embodiment, each of said regions may comprise absolute refractive indexes n_{i . . . x} of at least 1.20, such as up to about 2.0, the absolute refractive indexes n₁ are preferably in the interval from 1.30 to 1.40, such as around 1.32-1.34, such as about 1.33.

In one embodiment, the first dielectric cladding layer comprises a micro structuring in the form of areas with a modified refractive index e.g. modified by heat or other means as it is generally known in the art.

The plasmon polarition sub-unit of the invention may further comprise a first intermediate layer of a thickness up to about 100 nm, such as between 1 and 50 nm, such as a monolayer (e.g. a few Å), placed between the core and the first cladding. This layer may be a provided for obtaining an improved fixation of the core layer to the first cladding layer. This first intermediate material layer may e.g. be a polymer layer provided with a plasma method such as it is generally known in the art and e.g. using a method as disclosed in one of the publications. Mostly it is preferred that all layers, if more than one, are applied using a plasma method.

Method of applying coatings using plasma is generally known and further reference is made to patent applications P200000446 DK, U.S. Pat No. 5,876,753, WO 97/21497 U.S. Pat. No. 5,290,378, which are hereby incorporated by reference.

One embodiment of the evanescent field microscopy sub-unit further comprises a second intermediate material layer of a thickness up to about 100 nm, such as at least 1 nm e.g. between 10 and 50 nm placed between the core and the second cladding or on top of the core a part of the second classing not constituted by the specimen. The material layer may be applied using any conventional methods e.g. using plasma to form a CVD deposited polymer layer. Preferred methods for the CVD plasma process are as disclosed above. Other methods are disclosed in EP 0 741 404, WO 98 00457, WO 00 44207, WO 00 20656, WO 01 85635, WO 02 35895, WO 02 53299, WO 02 9496 and EP 1270 525.

In one embodiment, the second intermediate material layer is in the form of a capture layer, such as a layer comprising one or more of the following components containing charged groups, groups which modify the surface with respect to hydrophility/hydrophobicity, components in the form of a binding partner. The term “binding partner” means a molecule or a complex of molecules which is capable of interacting with a target substance e.g. a substance in the specimen.

The interaction between binding partners means a simple attraction, such as an ionic attraction or a hydrophobic/hydrophilic attraction or a bond such as a hydrogen bond, an ionic bond or a covalent bond. In general it is preferred that the interaction is a bond.

Preferably the capture layer comprises one or more of the components selected from the group consisting of acids, such as organic acids, amino acids, fatty acids and poly acids thereof; bases such as organic bases, amino acids and poly bases thereof; aromates such as benzene, naphthalene, anthracene, phenanthrene and substituted compounds thereof; metal components, such a organometals such as alkylmagnesium and lithium tri(tert-butoxy)aluminum hydride; halogen (I, Br, Cl, F) containing compounds such as 1-iod-2-methylpropane, flurocycohexane and methylthicyclohexane; zwitter ions e.g. ampholines; antigens and antibodies and combinations thereof.

In one embodiment, the capture surface comprises one or more binding partners which are specific. It is thus preferred that the one or more specific binding partners are specific for a biocomponent e.g. a biomolecule of microbial, viral, plant, animal or human origin or synthetic molecules resembling them, preferably selected from the group consisting of bacterium, virus, fungus, proteins, glyco proteins, nucleic acids, such as RNA, DNA including cDNA, PNA, LNA, oligonucleotides, peptides, hormones, antigens, antibodies, lipids, sugars, carbohydrates, and complexes including one or more of these molecules, said biomolecule or molecules preferably being selected from the group consisting of nucleic acids, antibodies, proteins and protein complexes.

The term biocomponent includes one or more biomolecules of microbial, plant, animal, viral, fungal or human origin or synthetic molecules resembling them, preferably selected from the group consisting of proteins, glyco proteins, nucleic acids, such as RNA, DNA including cDNA, PNA, LNA, oligonucleotides, peptides, hormones, antigens, antibodies, lipids, sugars, carbohydrates, and complexes including one or more of these molecules, said biomolecule or molecules preferably being selected from the group consisting of nucleic acids, antibodies, proteins and protein complexes.

The components of the capture layer e.g. the binding partner or partners may be linked optionally via a linking molecule to the sensor unit using conventional technology e.g. as disclosed in WO 00/36419, WO 01/04129, WO 96/31557, WO 99/38007, WO 02/48701, U.S. Pat. No. 6,289,717 and WO 0066266, which are hereby incorporated by reference.

In one embodiment, the capture layer comprises photochemically linked quinones selected from the group consisting of anthraquinones, phenanthrenequinones, benzoquinones, naphthoquinones, the quinones preferably being substituted by a functional group selected from the group consisting of carboxylic acids, sulfonic acid derivatives, esters, acid halides, acid hydrazides, semicarbazides, thiosemicarbaxides, nitriles, aldehydes, ketones, alcohols, thioles, disulphides, amines, hydrazines, ethers, epoxides, maleimides, succinimides, sulphides, halides and derivatives thereof.

Further information about quinones and the method of linking functional groups to a surface via a quinone and optionally a linker can be found in WO 96/31557, and WO 0104129, which are hereby incorporated by, reference.

The first cladding may in principle be of any type of material e.g. as disclosed above.

In a preferred embodiment the first cladding has a refractive index less than 1.4. Useful materials for such a cladding are e.g. disclosed in U.S. Pat. No. 5,024,507. This patent discloses the preparation of a cladding from a photopolymerizable composition comprising an unsubstituted or fluorosubstituted diacrylate monomer; a fluorinated monofunctional acrylate monomer in an amount of from about 2 to about 12 parts by weight per part by weight of the diacrylate monomer; a photoinitiator; and a viscosity modifying agent to increase the viscosity of the composition to about 1000 to about 15000 cP. Upon photocuring with ultra-violet radiation, the composition has a refractive index not greater than about 1.43, and preferably not greater than about 1.40. Similarly, U.S. Pat. Nos. 5,484,822, 5,492,987 and 5,534,558 describe a process for cladding an optical fiber, in which a photoinitiator monomer having both a photo initiating group and an ethylenically unsaturated group is reacted with a fluorosubstituted monomer having an ethylenically unsaturated group, thereby preparing a copolymer having pendant photo initiating groups. This copolymer is then mixed with a fluorosubstituted diacrylate, thereby forming a photopolymerizable composition, which is coated onto the optical fiber and exposed to ultraviolet light, thereby curing the photopolymerizable composition to produce the cladding. Preferred claddings of this type can have refractive indices below 1.35.

In one embodiment, the cladding comprises or is of a cyclic fluoropolymer, preferably a fluorine-containing thermoplastic resinous polymer as disclosed in U.S. Pat. No. 4,897,457.

A highly suitable cladding material is the material sold by Asahi Glass Europe, B.V.Amsterdam, the Netherlands, under the trade name CYTOP®. Most preferred is a CYTOP® material having refractive index about 1.33

The first dielectric layer may have any desired thickness sufficient for providing a generation of plasmons in the core/cladding interface when sandwiched between to equal claddings and the core is fed with light. There is no upper limit for the thickness.

In one embodiment, the first dielectric cladding layer has a thickness of at least 1 nm, such as at least 10 nm, such as at least 1 □m, such as at least 10 □m, such as between 1 □m and 10 mm, such as up to 0.1 mm.

The first cladding may in one embodiment be placed on a support unit for stabilizing the plasmon polarition sub-unit. Such support unit could e.g. be a Si wafer, a glass plate, a polymer plate a metal plate or similar.

In one embodiment, the evanescent field microscopy sub-unit according to the invention may comprise one or more additional layers applied on the side of the first dielectric cladding layer turning away from the core layer. In one embodiment, this one or more additional layers may include a feeding core layer coupling with the core layer, for at least one wavelength preferably a wavelength longer than 50 nm, and more preferably wavelength in the infrared, far infrared, visible and ultraviolet ranges, such as from 50 nm to 10000 nm, e.g. from 100 nm to 100 nm, such as from 200 nm to 2000 nm, such as from 400 nm to 1200 nm.

By applying such coupling system the feeding of the light into the core will be improved in that the intensity along the core will be stabilized since the feeding from the feeding core by coupling into the core will continue along the length of the core. In one embodiment, this feeding core embodiment includes a core with a varying thickness as disclosed above.

In one embodiment, the core layer comprises a wider section under or over the examination area, the wider section of the core layer comprising two or more crossing cores each adapted to be fed with light to generate surface plasmons in the cladding/core interface.

In one embodiment, the one or more additional layers applied on the side of the first dielectric cladding layer turning away from the core layer, include a feeding core layer and a third cladding layer, the feeding core layer being sandwiched between the first and the third claddings.

The refractive indexes of respectively the feeding core and the third cladding layer should preferably be so that light fed to the feeding core propagates along the feeding core and couples with the core to provide propagating waves along the core whereby plasmons are generated in the cladding/core interface.

In one embodiment the feeding core layer has a refractive index n₃ which is higher than n₁, such as at least 5% higher, such as at least 1% higher such as at least 0.1% higher such as at least 0.05% higher, preferably n₃ being between 0.05% and 0.1% higher than n₁.

In one embodiment the feeding core layer has a refractive index n₃ which is between 5 and 400% higher than n₁, such as between 20 and 300%, such as between 20 and 50% or between 150 and 200% higher than n₁.

The thickness of the feeding core layer may e.g. be between 1 μm and 5 μm, such as between 1 μm and 50 μm. The width and the length may preferably be the same as the width and the length of the core.

In one embodiment the thickness of the feeding core layer is between 25 nm and 1 μm, such as down to about 40 nm, such as down to 50 nm.

In one embodiment the dimensions of the core is selected so that it provides modes in the guiding structure with propagation constants similar to that of the propagation constant of a mode in the metal layer, when covered with a substance under investigation. The skilled person will by routine experiments be able to select such dimension.

It should be understood that two or more feeding cores may be placed side by side to propagate light e.g. with different wavelength for excitation of different fluorescent labels.

The third cladding layer may preferably have a refractive index n₄ which is at least 1.20, such as up to about 2.0, absolute refractive index n₄ is preferably in the interval from 1.30 to 1.40, such as around 1.32-1.34, such as about 1.33, and preferably n₄ is equal to n₁.

The thickness of the first cladding layer may preferably be between 0.01 μm and 5 82 m.

The thickness of the third cladding layer may in principle be as thick as desired. In one embodiment the thickness of the third cladding layer is between 0.01 μm and 5 μm.

The principle of coupling light from one core to another is generally known. Relevant information can e.g. be found in U.S. Pat. No. 6,571,035 and U.S. Pat. No. 5,778,119.

In this embodiment including a feeding core it may be desired that the third cladding be placed on a support unit for stabilizing the plasmon polarition sub-unit. Such support unit could e.g. be a Si wafer, a glass plate, a polymer plate a metal plate or similar.

In one embodiment the evanescent field microscopy sub-unit according to the invention comprises a light coupling unit for coupling light into the core optionally via a feeding core. This coupling unit preferably comprises an optical fiber or a planar optical integrated circuit (e.g. PLC).

The coupling unit may further comprise optical modulators such as one or more lenses or prisms, one or more gratings and other in order to focus the light into the core or the feeding core as desired. A lens may e.g. be provided for spreading or for gathering the light to focus it into the core/feeding core. Such coupling units are generally known in the art.

By integrating a light coupling with the evanescent field microscopy sub-unit a more stable system may be provided. The coupling unit may preferably be fixed to a support unit onto which the first or third cladding layer is also supported.

The integrated light coupling unit may be in the form of a prism coupling device or a grating coupling unit imprinted in either of the cladding layers, feeding core layers or support unit e.g. as shown in FIGS. 10 and 11.

As mentioned above, the evanescent field microscopy sub-unit is arranged to support a specimen to form a part or all of a second cladding on the side of the core layer opposite the first cladding layer.

In one embodiment, the evanescent field microscopy sub-unit comprises a specimen support unit adapted to support the specimen to thereby bring the specimen into a distance of the core layer, preferably of 2 μm or less, such as a distance of 1 μm or less, such as in direct contact with the core or in direct contact with a second intermediate layer as disclosed above.

In one embodiment, the specimen support unit is in the form of a slide or a container, such as a slide or a container placed below the core. The evanescent field microscopy sub-unit is placed onto the specimen support unit and optionally pressed slightly against it to obtain the desired distance between the core and the specimen. The distance between the core and the specimen may thereby be varied.

In one embodiment, the specimen support unit is in the form of a flow cell, at least a part of the first cladding and the core being placed within the flow cell. In this embodiment, the specimen is a liquid specimen. The evanescent field microscopy sub-unit preferably comprises a second intermediate layer placed onto the core, preferably in the form of a capture layer. Thereby a desired substance of the specimen will be captured by the capture layer where after it can be further examined.

In one embodiment, the sub-unit is arranged to support a specimen to form a part of a second cladding on the side of the core layer opposite the first cladding layer, and the sub-unit comprises a specimen cavity formed in the part of a second cladding layer, the specimen cavity being adapted to form a specimen support unit.

The cavity may so deep that a bottom part is constituted by the core or a second intermediate coating. The remaining part of the second cladding may preferably be of a material having a refractive index as disclosed above for the first cladding and preferably the cladding material for the first and second cladding not constituted by the specimen may be of the same material. The surface of the cavity provided by second cladding material may e.g. be coated to protect it from the specimen, e.g. for easy cleaning.

As mentioned above, the evanescent field microscopy sub-unit may comprise means for regulating the distance between the specimen support unit and the core.

As mentioned above, the evanescent field microscopy sub-unit may be a part of an examination system or it may even be an integrated part of an examination system.

When a specimen is placed on the evanescent field microscopy sub-unit to fill the specimen support, the unit is designated an evanescent field microscopy unit.

In a second aspect of the evanescent field microscopy sub-unit of the invention the core need not be as thin as disclosed above, but may be formed to be a mulitmode guide the materials and the structure of the first and second cladding may be as above. In this second aspect of the invention a feeding core may be superfluous because it in general will be relatively simple to pump the light into the core, e.g. using the light sources as described herein e.g. with a modulation as described below.

The evanescent field microscopy sub-unit of the second aspect is in the form of a chip comprising a core layer sandwiched between a first cladding layer and a second cladding layer, wherein the second cladding layer comprises an aperture to provide a cavity for a specimen. The cavity has a bottom provided by the core layer, and the first and the second cladding layer have essentially identical refractive indexes. The chip may be used in the examining system disclosed herein.

In one embodiment of the second aspect the first cladding layer is spun unto a supporting substrate. Thereby the supporting substrate can be selected as desired without limitation relating to its refractive index. As examples for the supporting substrate can be mentioned glass, silicon and polymers. The first cladding layer should preferably have a thickness of at least 1 μm, such as between 2 and 10 μm, preferably about 4 μm. The second cladding layer may have a similar thickness except for the aperture for the specimen cavity.

In one embodiment of the second aspect the first and the second cladding layer is of a fluoro polymer as disclosed above, such as CYTOP®

In one embodiment of the second aspect the first and the second cladding layer is of similar materials with a refractive index in the range 1.33-1.40.

In one embodiment of the second aspect the core layer has a thickness which is sufficient high for being a multimode core for at least one optical wavelength above 1 nm. A preferred thickness in the range between 2 and 25 μm, such as between 10 and 20 μm. The core layer may preferably be of a polymer or of glass. For simplification of production polymer is most preferred. The refractive index of the core layer should be higher than the refractive index of both of the first and the second cladding layers. In order to obtain a high N.A. value, which makes is more simple to feed light into the core, the refractive index of the core should preferably be relative high, such as at least 1.45 and preferably between 1.49 and 1.53.

The specimen to be examined using the evanescent field microscopy sub-unit of the second aspect of the invention, may be as disclosed above, preferably in the form of a support matrix comprising one or more substances to be examined. The support matrix may preferably have a refractive index which matches the refractive index of the second cladding. As a preferred support matrix can be mentioned an aqueous liquid, such as an aqueous buffer.

In principle the evanescent field microscopy sub-unit of the second aspect of the invention, will operate in the same way as the evanescent field microscopy sub-unit having a single mode configuration (with relatively thin core layer). When multimode light is guided along the core layer, an evanescent tail will be radiated into both of the cladding layers. Due to the index match between the support matrix of the specimen and the second cladding the interface between these two materials will not result in any undesired light reflection.

In general the evanescent field microscopy sub-unit will be sold without a specimen e.g. as a part of an examination system as described in the following.

The invention therefore also relates to an examination system for examination of a specimen, and comprising an evanescent field microscope sub-unit, such as a surface plasmon polarition sub-unit, a light source and a detector unit.

The evanescent field microscopy sub-unit may preferably be as disclosed above.

The light source is coupled to the evanescent field microscopy sub-unit for guiding light into its core, wherein said core has a thickness tm, selected so as to in combination with the light source generate and propagate surface plasmons along core/cladding interfaces of a hypothetical evanescent field microscopy test unit differing from the evanescent field microscopy sub-unit in that it comprises a hypothetical second cladding layer identical with the first cladding layer on the side of the core layer opposite the first cladding layer.

The detector unit is adapted to collect a signal induced by light guided in said core.

The light source may in principle be any type of light source.

The source in general is defined as any source with brightness high enough to couple sufficient power for a specific purpose into the core (also designated LR-SPP waveguide) of the sub-unit.

Sources suitable for such purposes involve primarily laser sources. Types of lasers suitable for the purpose involve gas lasers (e.g. HeNe, Ar-ion, HeCd lasers), solid state lasers (e.g. Nd:YAG, Ti:Sapphire, diode lasers, fiber lasers etc.), Vertical cavity laser (VCSEL) and liquid lasers (dye lasers). In addition suitable sources also involve lasers in combination with any sub-system for laser beam transformation such as spectral transformations (e.g. frequency conversion, spectral broadening and ultimately continuum generation) and temporal transformations (pulsing and pulse compression).

In addition to lasers suitable sources also involve sources such as e.g. an amplified stimulated emission (ASE) fiber source and edge emitting light emitting diodes (EE-LEDs) which are characterized by low temporal coherence but high brightness of the output. Such sources generally have much lower spectral density than the lasers but provide spectrally broader emission making them useful for applications where spectral characteristics are of importance. Again suitable sources also involve high brightness broadband sources in combination with any subsystem for spectral and temporal transformation of the light such as monochromators or devices for pulsing of the light.

Finally suitable sources can in principle involve low brightness white light sources such as e.g. a Xe-lamp. From such sources the spectral density of light coupled to the source is in general very low but may be useful for specific purposes.

In one embodiment, the light source is capable of pumping light with wavelength at longer optical wavelength, such as longer than 50 nm, and preferably wavelength in the infrared, far infrared, visible and ultraviolet ranges, such as from 50 nm to 10000 nm, e.g. from 100 nm to 100 nm, such as from 200 nm to 2000 nm, such as from 400 nm to 1200nm.

The light source pump to work together with the evanescent field microscopy sub-unit can couple to the evanescent field microscopy waveguide directly, via an end-coupling scheme or via an evanescent wave coupling scheme.

In one embodiment, the spatial intensity distribution of the incident light in the plane of the facet essentially overlaps with that of the LR-SPP mode profile. One way of achieving this is to place an end of the core or feeding core in direct continuation of the output facet of a light source with an output intensity distribution matching the mode of the LR-SPP guide.

From such sources light can also be delivered to the plasmon polarition sub-unit via an optical fiber coupled in one end to the source and in the other end to the waveguide of the LR-SPP sub-unit. In an alternative approach the output from a light source can be transformed from the source onto the facet via a suitable optical system in such a way as to achieve the best overlap of the output from the source with the mode.

In another scheme the light is coupled to the LR-SPP guide via light propagation parallel to the core but confined by a guiding structure namely the feeding core in the bottom cladding layer. The light can in principle be delivered to the lower guiding structure from any source similar to those described above. Preferably the guide is designed in such away that at least one mode of the guiding structure has a propagation constant substantially identical to the one above.

The detector may in principle be any type of detector that can detect a signal provided by the evanescent waves when it hits the specimen. The detector may e.g. be a photo detecting system e.g. comprising a photodiode or a photo or radioactive sensitive film.

In one embodiment, the detector unit is a light detector detecting the light output, the light detector preferably comprising a CCD detector array and a signal processing unit.

In one embodiment, the detecting unit is capable of detecting and calculating change in refractive index of a specimen.

Such detection units are generally known in the art.

In one embodiment, the said detector unit is an image collecting unit, preferably in the form of a microscope and/or a sensor such as a photo detector.

In one embodiment, the detector unit is adapted to collect a light signal e.g. in the form of a fluorescent signal coming from the side of the core layer opposite the first cladding layer.

Method of detecting fluorescent signals which may be used in the present invention is e.g. disclosed in US 2003/0058530, U.S. Pat. No. 6,225,636 and U.S. Pat. No. 625,642.

In one embodiment of the examination system for examination of a specimen according to the invention, the plasmon polarition unit and the light source in combination are capable of generating and propagating surface plasmons along core/cladding interfaces of a hypothetical evanescent field microscopy test unit differing from the evanescent field microscopy sub-unit in that it comprises a hypothetical second cladding layer identical with the first cladding layer on the side of the core layer opposite the first cladding layer, so as to in combination with the light source generate an evanescent plasmon polarition field in the hypothetical second cladding, wherein the evanescent plasmon polarition field preferably has an extension in the z direction into the hypothetical second cladding, which is at least 50 nm, such as at least 100 nm, such as at least 1 μm such as up to about 10 μm e.g. around 5 μm.

Thereby a major progress is provided compared with the state of the art. By using this examination system it will be possible to follow processes in the specimen e.g. in the form of a living cell, which has hitherto not been possible.

In use of the examination system for examination of a specimen, a specimen is placed to be supported by the evanescent field microscopy sub-unit to thereby form a part or all of its second cladding opposite its first cladding. The specimen may e.g. be placed on, under or pressed onto the core or the second intermediate layer as disclosed above, e.g. by being placed in a cavity of second cladding material other than specimen in or the evanescent field microscopy sub-unit may be placed partly or totally in a flow cell so that at least a part of the first cladding and the core are placed within the flow cell.

Thereafter light is guided into the core and a signal can be detected.

The invention also relates to a evanescent field microscopy unit comprising a first and a second dielectric cladding layer sandwiching a core layer, the first cladding layer has an absolute refractive index n₁, said core layer being coated onto at least a part of said first cladding layer, and the second cladding layer comprising a specimen wherein said specimen comprises a substance to be investigated immersed in a support matrix having an absolute refractive index n₂, wherein n₁=A×n₂, where 0.95≦A≦1.05, preferably 0.98≦A≦1.02 and even more preferably wherein n₁=A×n2, 0.99≦A≦1.01.

It has thus been found by the inventors that by providing the first and second cladding with refractive indexes in the above interval, a particularly good propagation along the core with generation of plasmons in the core cladding interface has been achieved.

The evanescent field microscopy unit preferably comprises an evanescent field microscopy sub-unit as disclosed above and a specimen constituting a part of the second cladding. In one embodiment the evanescent field microscopy unit is a surface plasmon polarition unit and comprises a surface plasmon polarition sub-unit.

The specimen comprises a support matrix and one or more substances to be examined.

In one embodiment, the support matrix of the specimen has an absolute refractive index n₅ which is at least 1.20, such as up to about 2.0, absolute refractive index n₅ is preferably in the interval from 1.30 to 1.40, such as around 1.32-1.34, such as about 1.33, and preferably n₅ is equal to n₁.

The support matrix may in principle be any kind of matrix containing the substance to be examined.

In one embodiment, the substance is a gas e.g. air. The specimen may be a dried material e.g. freeze dried. The gas may preferably be pressurized to increase its refractive index. In this it is desired that the refractive index n₁ of the first cladding layer is between 1 and 2 and in particular between 1 and 1.5.

In one embodiment, the support matrix is a liquid e.g. in the form of an aqueous buffer, in the form of biological fluid such as milk, saliva, blood plasma, urine or other liquids such as water samples, beverage e.g. beer and vine. The liquid may also be a solvent e.g. DMSO.

In one embodiment, the support matrix is a solid material and the substance is contained therein. Such a solid material may e.g. be a polymer such as styrene or polyolefin, e.g. EPON.

In one embodiment, the support matrix is a gel, such as gelatin and gels which is usually used for electrophoresis e.g. as disclosed in WO 93/11174 and WO 97/16462, and WO 00/56792.

In one embodiment, the support matrix of the specimen is selected from the group consisting of human liquid, such as serum, organic or an aqueous medium. Preferably the support matrix comprises at least 25% by vol. of water, such as at least about 45% by vol. of water, the support matrix may preferably further comprise other components such as acetic acid, ethanol, glycerol, detergents such as CHAPS (3-[(3-cholamidopropyl)-dimethylammonio]-1-propanesulfonate (detergent)) and SDS (Sodium Dodecyl Sulphate (charged detergent)) and buffer systems e.g. comprising one or more components e.g. including chaotopic agents, such as for example of the following components [symbol] □-mercaptoethanol, urea, thiourea, guanidinium chloride and DTT).

The substance to be examined may in principle be any type of substance e.g. in the form of a biocomponent as disclosed above. In one embodiment, the substance of the specimen is selected from the group consisting of beads, spheres synthetic surfaces, e.g. provided by plasma or wet chemistry, polymers, tissues, cells, body fluids, blood components, microorganism including procaryotic and eucaryotic, and derivatives thereof, or parts thereof, such as membranes, cell walls, proteins, glyco proteins, fusion proteins nucleic acids, such as RNA, DNA, cDNA, LNA, PNA, amino modified components, oligonucleotides, peptides, hormones, antigen, antibodies, lipids, vesicles, and complexes and aggretes including one or more of these molecules.

In one embodiment, the substance of the specimen is excitable by subjection to a plasmon field to thereby generate a light signal, said substance preferably being selected from the group consisting of amino acids, DNA, proteins, peptides, the substances preferably being excitable by subjection to a plasmon field generated by light with a wavelength of between 250 and 350 nm.

In one embodiment, the substance to be detected preferably in the form of DNA or protein is subjected to a hybridisation with latex particles conjugated to synthetic oligodeoxynucleotides as described in “Quantification of DNA using the luminescent oxygen channeling assay” by Rajesh Patel et. al, Clinical Chemistry 46:9, 1471-1477 (2000).

The substance may be marked e.g. with a fluorescent label such as it is generally known in the art e.g. fluorescent labels selected from the group consisting of metals e.g. gold, polysulfated hydrocarbon dyes (e.g. Trypan Blue), GFP proteins, DS-red, FITC, TRIC, Phycoerythriner, Rhodaminer, Fluorchromes. In one embodiment two or more fluorescent labels preferably excitable at different wavelength may be used.

The invention also relates to an examination system in combination with a specimen for examination of said specimen, said system comprising an evanescent field microscopy unit, a light source and a detection unit.

The evanescent field microscopy unit comprises a first and a second dielectric cladding layer sandwiching a core layer, the first cladding layer having an absolute refractive index n₁, said core layer being coated onto at least a part of said first cladding layer, and said second cladding layer comprising said specimen wherein said specimen comprises a substance to be investigated immersed in a support matrix having an absolute refractive index n₂, wherein n₁=A×n₂, where 0.2≦A≦1.2.

In a preferred embodiment n₁=A×n₂, 0.99≦A≦1.01.

The light source is coupled to the evanescent field microscopy unit for guiding light into its core, wherein the core has a thickness tm, selected so as to in combination with the light source generate and propagate surface plasmons along said core/cladding interfaces and whereby an evanescent plasmon polarition field capable of interacting with the substance is generated in the secondary cladding to thereby generate a signal.

The detection unit is adapted to collect this signal.

The evanescent field microscopy unit of the examination system in combination with a specimen may preferably be as disclosed above.

The light source may be as disclosed above.

In order to decrease or completely avoid formation of undesired interference pattern in the measurement area the system may in one embodiment comprise a modulation arrangement for the light.

In one embodiment the modulation arrangement for the light is in the form of an arrangement which modulates a fiber feeding the light to the core. This embodiment is particular applicable when the fiber for feeding the core is a multi mode fibre. The modulation arrangement is capable of vibrating the fiber with a sufficiently high frequency to blurring any undesired interference pattern for the detector. When a multimode fiber is subjected to vibrations the phase relation between the modes will be constantly changed and thereby change the interference pattern. In one embodiment the multimode fiber is subjected to vibrations using an actuator, such as a piezo electrical crystal.

In one embodiment the modulation arrangement for the light is in the form of an arrangement which modulates the emitting wavelength(s) of the light source. In practice a modulation of the emitting wavelength(s) of the light source results in a constantly changing of the interference pattern. The modulation should preferably be sufficiently large to blurring the interference pattern.

When using a diode laser as light source the wavelength may e.g. be modulated by modulation iof the electrical signal which is feeding the diode lase. By controlling the electrical power through the laser diode cavity, the temperature in the cavity will change and thereby the refractive index of the medium in the cavity will change. When the optical properties changes, the wavelength(s) of the emitted light will thereby change accordingly.

When using an External cavity lasers (ECL) as light source the laser may be tuned. When the ECL comprises a grating coupled in a Littman or a Ludrow configuration The wavelength may be tuned by well known methods, such as described in “Tunable lasers Handbook” by F. J. Duarte (Capture 8).

Alternatively the ECL may be subjected to a mechanical modulation as disclosed above using an actuator.

In one embodiment the modulation arrangement for the light is in the form of an arrangement which modulates the light by diffusion. In this embodiment the modulation arrangement for the light is a diffusion arrangement, which may be build into the core layer of the evanescent field microscope sub-unit. The diffusion arrangement is arranged to disturb or even destroy the coherence of the light and thereby decrease or completely remove any interference pattern.

The diffusion arrangement may e.g. be provided by arranging one or more rows of columns of another material than the core material, but where the refractive index of the columns is above the refractive index of the first and second cladding material(S). The height of the column may be up to the height of the core, e.g. in the range of between 10 and 100% of the height of the core. The row of columns should preferably be placed essentially perpendicular to the propagate direction of the light. The rows of column may preferably be slightly displaced in relation to each other i.e. second row of column is displaced slightly to one side, third row of column is displaced further to this one side and so on until the displacement comprises a whole displacement period and the columns of the following row of column is placed on line with the columns of the first row of columns.

In a variation thereof a number of columns are incorporated into the core to spread the light on the evanescent field microscope sub-unit so that the column seen in the XY-plan is arranged in a lens shape.

The light source and/a coupling or a part thereof may be integrated with the evanescent field microscopy unit e.g. by being spliced with a coupling which may be spliced with the light source or the light source is focusing the light into the coupling.

In one embodiment, the light source is focusing the light directly into the core or the feeding core. Such a coupling is often referred to as a free space coupling.

In one embodiment, the light source is guiding light into a fiber coupling or a planar optical circuit coupling from where the light is focused via a free space coupling into the core or into a feeding core.

In one embodiment, the evanescent field microscopy unit comprises a feeding core layer coupling with the core layer, the light source being coupled to said evanescent field microscopy unit for guiding light into said core layer via said feeding core layer as described above.

The detector may be as described above.

The detector preferably is capable of detecting and calculating change in refractive index of a specimen, detecting a fluorescent signal or detecting a change of the light waves guided in the core.

Preferably the detector unit is an image collecting unit, more preferably in the form of a microscope or a sensor such as a photo detector.

In one embodiment, the detector unit is adapted to collect a light signal e.g. in the form of a fluorescent signal coming from the side of the core layer opposite the first cladding layer.

In one embodiment, the evanescent field microscopy unit and said light source in combination are capable of generating and propagating surface plasmons along said core/cladding interfaces and whereby an evanescent plasmon polarition field capable of interacting with the substance is generated in the secondary cladding to thereby generate a signal, wherein the evanescent plasmon polarition field preferably has an extension in the z direction into the hypothetical second cladding, which is at least 50 nm, such as at least 100 nm, such as at least 1 μm such as up to about 10 μm e.g. around 5 μm.

The invention also relates to a microscope comprising an evanescent field microscopy sub-unit as disclosed above. The microscope may preferably be in the form of an examination system disclosed above.

In one embodiment, the plasmon polarition sub-unit is removable. This provides an easy way to replace this part. Furthermore the examination may comprise two or more plasmon polarition sub-unit with different core thickness, with different distance from core to specimen or with different refractive indexes.

The microscope may in principle be constructed as a conventional microscope with the additional units, an evanescent field microscopy sub-unit as disclosed above and a light source as disclosed above capable of guiding light into the evanescent field microscopy sub-unit as disclosed above. Additionally it may comprise a detector unit as disclosed above.

The invention also relates to a sensor comprising a evanescent field microscopy sub-unit as disclosed above, a light source as disclosed above for feeding light into the core of the evanescent field microscopy sub-unit as disclosed above, and a light detector as disclosed above for detecting the light output surface from the core of the plasmon polarition sub-unit, the light detector may preferably comprise a CCD detector array and a signal processing unit.

For the same reasons as for the microscope, the plasmon polarition sub-unit may preferably be removable.

The invention also relates to a set of evanescent field microscopy sub-units comprising at least two evanescent field microscopy sub-units, each of them individually from each other being as disclosed above, and the evanescent field microscopy sub-units respectively being arranged to support a specimen to form a part or all of its second cladding on the side of the core layer opposite its first cladding layer so that the distance from the core to the specimen in one evanescent field microscopy sub-unit differs from the distance from the core to the specimen in another one of the evanescent field microscopy sub-units.

### BRIEF DESCRIPTION OF DRAWINGS

The invention will be explained more fully below in connection with a preferred embodiment and with reference to the drawings in which:

FIG. 1a shows a schematic side view of a first embodiment of an evanescent field microscopy sub-unit according to the invention.

FIG. 1b shows a top view of the embodiment shown in FIG. 1a.

FIG. 2a shows a schematic side view of a second embodiment of an evanescent field microscopy sub-unit according to the invention.

FIG. 2b shows a top view of the embodiment shown in FIG. 2a.

FIG. 3a shows a schematic side view of a third embodiment of an evanescent field microscopy sub-unit according to the invention.

FIG. 3b shows a top view of the embodiment shown in FIG. 3a.

FIG. 4a shows a schematic side view of a fourth embodiment of an evanescent field microscopy sub-unit according to the invention.

FIG. 4b shows a top view of the embodiment shown in FIG. 4a.

FIG. 5a shows a schematic side view of a fifth embodiment of an evanescent field microscopy sub-unit according to the invention.

FIG. 5b shows a top view of the embodiment shown in FIG. 5a.

FIG. 6 is a schematic perspective view of the fourth embodiment of an evanescent field microscopy sub-unit according to the invention.

FIG. 7 is a schematic perspective view of a fifth embodiment of an evanescent field microscopy sub-unit according to the invention.

FIG. 8 is a schematic perspective view of an examination system according to the invention in the form of a microscope.

FIG. 9a shows a schematic side view of a sixth embodiment of an evanescent field microscopy sub-unit according to the invention.

FIG. 9b shows a top view of the embodiment shown in FIG. 9a.

FIG. 10 shows a schematic side view of a first embodiment of an evanescent field microscopy unit according to the invention.

FIG. 11 shows a schematic side view of a second embodiment of an evanescent field microscopy unit according to the invention.

FIG. 12 shows a schematic side view of a third embodiment of an evanescent field microscopy unit according to the invention.

FIG. 13 shows experimental results obtained from a structure according to a fourth evanescent field microscopy unit shown in FIG. 14.

FIG. 14 shows schematic side view of a fourth evanescent field microscopy unit according to the invention.

The figures are schematic and simplified for clarity, and they merely show details which are essential to the understanding of the invention, while other details are left out. Throughout, the same reference numerals are used for identical or corresponding parts.

### DETAILED DESCRIPTION OF THE PREFERRED EMBODIMENTS

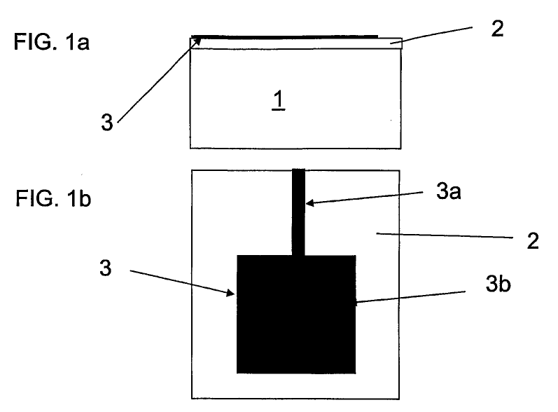

FIGS. 1a and 1b show respectively a side view and a top view of a first embodiment of an evanescent field microscopy sub-unit according to the invention. The evanescent field microscopy sub-unit comprises a support unit 1, e.g. in the form of a wafer such as BK7 wafer. Onto the support unit 1 is placed a first cladding layer 2 and thereon is placed a core layer 3. As can be seen in FIG. 1b, the core layer has a smaller width 3a close in the end from where the light is to propagate from, followed by a wider section 3b placed beneath or above the area supposed to support a specimen.

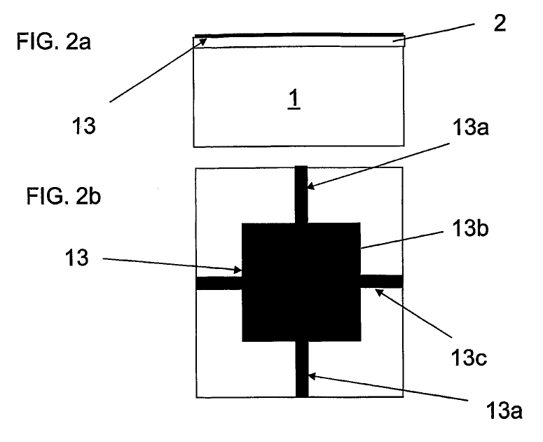

The embodiment shown in FIGS. 2a and 2b. differs from the embodiment shown in FIGS. 1a and 1b only in that the core layer 13 comprises a wider section 13b under or over the examination area, and that this wider section of the core layer comprises two crossing cores 13a, 13c, each adapted to be fed with light to generate surface plasmons in the cladding/core interface.

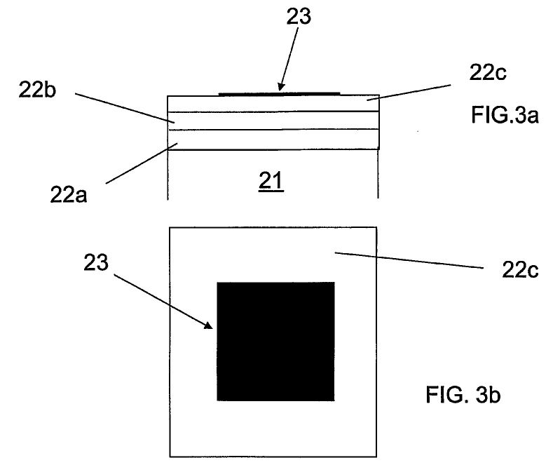

FIGS. 3a and 3b show respectively a side view and a top view of a third embodiment of an evanescent field microscopy sub-unit according to the invention. The evanescent field microscopy sub-unit comprises a support unit 21, e.g. in the form of a wafer such as BK7 wafer. Onto the support unit 21 is placed, in the mentioned order, a third cladding layer 22a, a feeding core layer 22b and a first cladding layer 22c. Onto the first cladding layer 22c is placed a core layer 23 having square form. It will be observed that the core layer can not be end fed but has to be fed via the feeding core as described above.

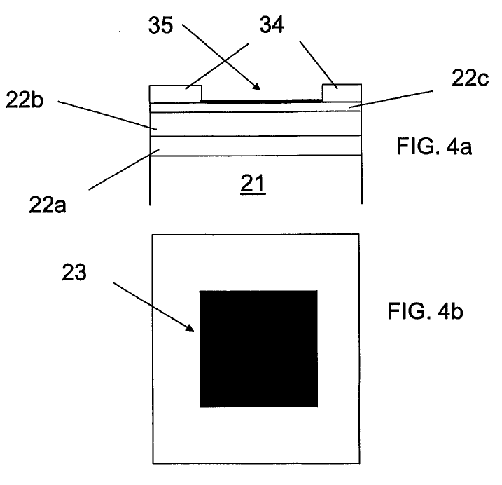

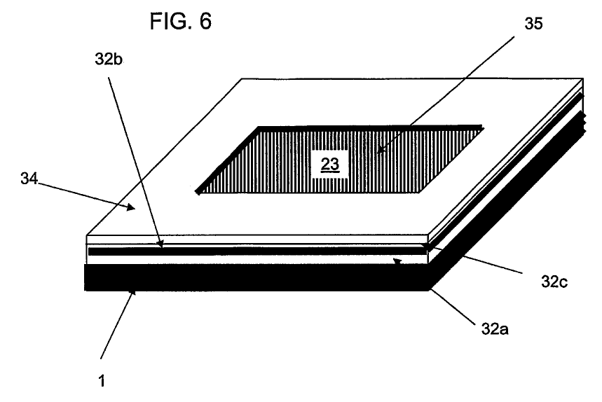

The embodiment shown in FIGS. 4a and 4b and 6 differs from the embodiment shown in FIGS. 3a and 3b only in that this fourth embodiment comprises a part of a second cladding 34 on the side of the core layer opposite the first cladding layer. The part of the second cladding 34 forms together with the core layer a cavity 35 for supporting a specimen.

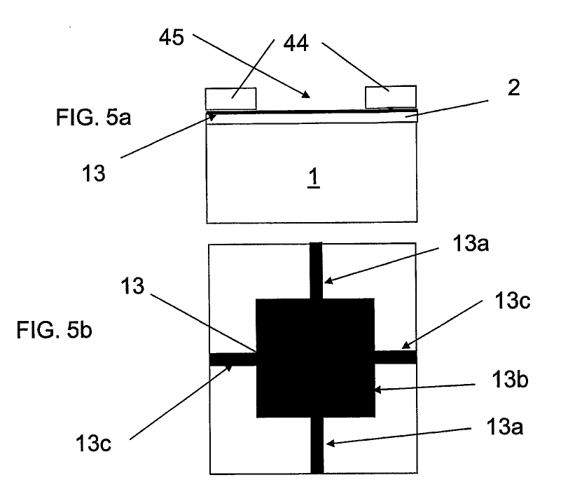

The embodiment shown in FIGS. 5a and 5b differs from the embodiment shown in FIGS. 2a and 2b only in that this fourth embodiment comprises a part of a second cladding 44 on the side of the core layer opposite the first cladding layer. The part of the second cladding 44 forms together with the core layer a cavity 45 for supporting a specimen.

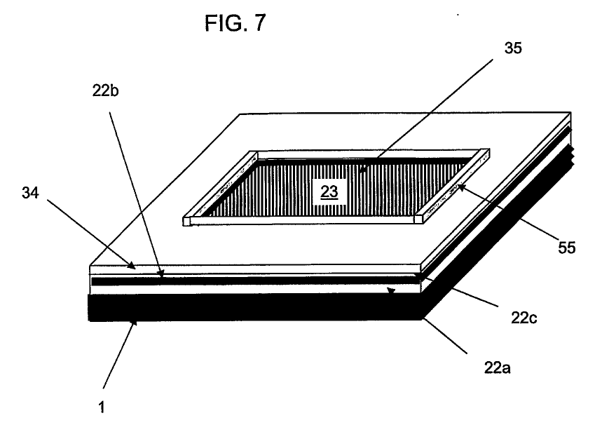

The embodiment shown in FIG. 7 differs from the embodiment shown in FIG. 6 only in that this fifth embodiment comprises an additional support 55 for a specimen.

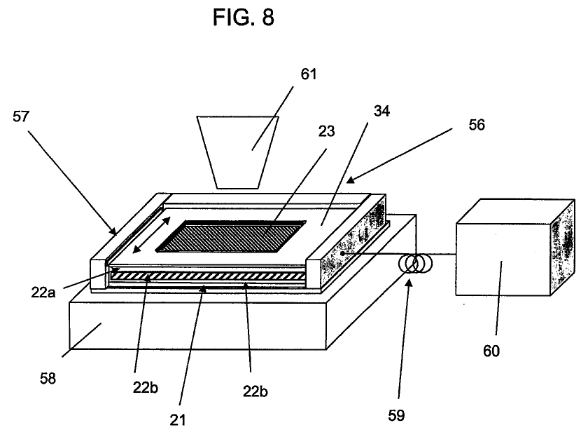

The examination system according to the invention shown in FIG. 8 comprises an evanescent field microscopy sub-unit 56 as disclosed in FIG. 6. The evanescent field microscopy sub-unit 56 is removable inserted into a sub-unit support frame 57 placed onto an additional support unit 58 e.g. in the form of a microscope table. By applying the evanescent field microscopy sub-unit 56 removable in a sub-unit support frame 57, different evanescent field microscopy sub-units may be used e.g. for the possibility and changing of the penetration depth. Furthermore the evanescent field microscopy sub-unit may be easy to clean. The support frame 57 ensures that a safe position can be obtained for bringing an optimal amount of light into the feeding core. Light is guided into the feeding core 32b via an optical fiber 59 guiding light from a fiber coupled light source 60. As indicated, a detection unit 61 e.g. in the form of a microscope objective may be placed above the examination area provided by the upper surface of the core 23.

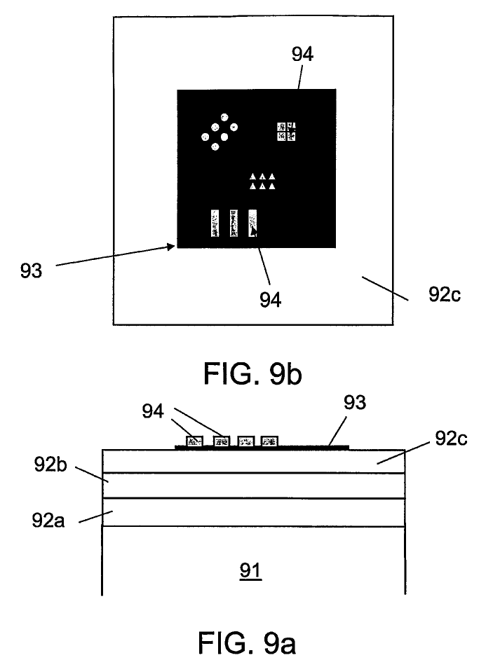

FIGS. 9a and 9b show respectively a side view and a top view of a sixth embodiment of an evanescent field microscopy sub-unit according to the invention. The evanescent field microscopy sub-unit comprises a support unit 91, e.g. in the form of a wafer such as BK7 wafer. Onto the support unit 91 is placed, in the mentioned order, a third cladding layer 92a, a feeding core layer 92b and a first cladding layer 92c. Onto the first cladding layer 92c is placed a core layer 93 having square form. It will be observed that the core layer can not be end fed but has to be fed via the feeding core as described above. The metallic surface of the core 93 comprises nano-structured features 94. The nano-structured features can have geometrical shape and be arrange a single features or in both periodic and nonperiodic arrays.

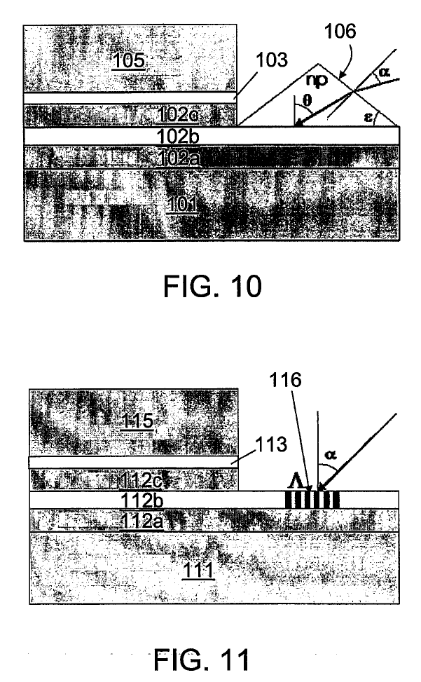

FIG. 10 shows a schematic side view of a first embodiment of an evanescent field microscopy unit according to the invention. The evanescent field microscopy unit comprises a support unit 101, e.g. in the form of a wafer such as BK7 wafer. Onto the support unit 101 is placed, in the mentioned order, a third cladding layer 102a, a feeding core layer 102b and a first cladding layer 102c. Onto the first cladding layer 102c is placed a core layer 103. Onto the core layer 103 is placed an aqueous solutions comprising the sample to be examined.

The support unit 101, the third cladding layer 102a and the feeding core layer extend beyond the remaining of the structure, and a prism 106 is placed onto the feeding core layer 103b, whereby light can be fed into the feeding core 102b via the prism.

The coupling of a laser beam by a prism into a planar dielectric waveguide is governed by the angle αof incidence of the light onto the prism. Under certain conditions, the light energy can be transferred into the waveguide (the feeding core 102b) by the evanescent fields that are excited in a gap between the prism and the feeding core 102b. These conditions are that the incident beam must have the proper angle of incidence so the evanescent field in the gap travels with the same phase velocity as the mode to be excited in the feeding core 102b, the incident beam must have the same polarization as the mode to be excited and the prim must be placed close to the planar dielectric waveguide, here the feeding core. Typically the gap is in order of half a wavelength.

FIG. 11 shows a schematic side view of a second embodiment of an evanescent field microscopy unit according to the invention. The evanescent field microscopy unit comprises a support unit 111, e.g. in the form of a wafer such as BK7 wafer. Onto the support unit 111 is placed, in the mentioned order, a third cladding layer 112a, a feeding core layer 112b and a first cladding layer 112c. Onto the first cladding layer 112c is placed a core layer 113. Onto the core layer 113 is placed an aqueous solutions comprising the sample to be examined.

The support unit 111, the third cladding layer 112a and the feeding core layer extend beyond the remaining of the structure, and a grating 116 is microstructured in the feeding core layer 113b, whereby light can be fed into the feeding core 112b via the grating 116.

The coupling of a laser beam by a grating into a planar dielectric waveguide, here the feeding core layer 113b, is also governed by the angle αof incidence of the light onto the grating. The coupling of light into the feeding core layer 113b by means of a grating coupler occurs at angles a according to
neff−n*sin(α)=m*λ/Λ

where neff is the effective refractive index of the waveguide mode excited by the input coupling. The refractive index of the surrounding media, here the first and the second cladding is denoted n, the vacuum wavelength λ, the grating periodicity Λ, and the diffraction order m.

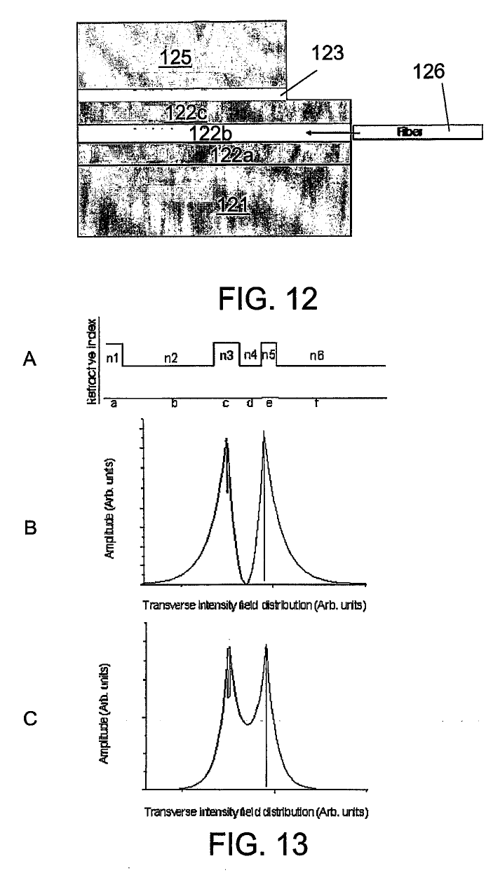

FIG. 12 shows a schematic side view of a third embodiment of a evanescent field microscopy unit according to the invention. The evanescent field microscopy unit comprises a support unit 121, e.g. in the form of a wafer such as BK7 wafer. Onto the support unit 121 is placed, in the mentioned order, a third cladding layer 122a, a feeding core layer 122b and a first cladding layer 122c. Onto the first cladding layer 122c is placed a core layer 123. Onto the core layer 123 is placed an aqueous solutions comprising the sample to be examined.

A single-mode fiber 126 is coupled to the feeding core layer 122b whereby light can be fed using Butt coupling technique into the feeding core 122b via the single-mode fiber 126.

Butt coupling technique: The coupling of a laser beam by a butt coupling into a planar dielectric waveguide is governed by the mode matching of a laser beam to the mode of the dielectric waveguide, here the feeding core 122b. Preferably, the laser beam is butt-coupled from a single-mode fiber or objective, perpendicular to the surface, into planar waveguides in question.

FIG. 14 shows schematic side view of a fourth evanescent field microscopy unit according to the invention.

The evanescent field microscopy unit comprises a support unit 141, in the form of a SI-substrate. Onto the support unit 141 is placed, in the mentioned order, a third cladding layer 142a in the form of a 8 μm thick layer of CYTOP, a feeding core layer 142b in the form of a 49 nm thick layer of PMMA, and a first cladding layer 142c in the form of a 2.3 μm thick layer of CYTOP. Onto the first cladding layer 142c is placed a core layer 143 in the form of an 8 nm thick layer of gold. Onto the core layer 143 is placed a liquid solution 144 comprising the samples 105 to be examined.

A detection unit 147 in the form of a microscope objective is placed above the liquid sample 144.

A single-mode fiber 146 is coupled to the feeding core layer 142b whereby light can be fed using Butt coupling technique into the feeding core 142b via the single-mode fiber 146.

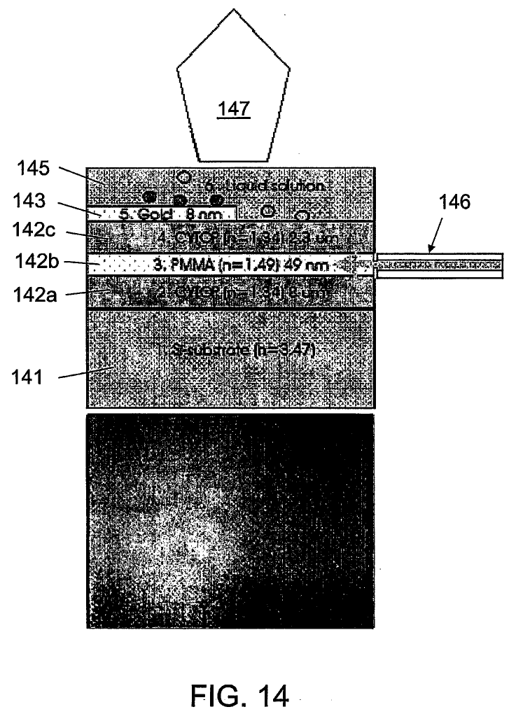

FIG. 13 shows experimental results obtained from a structure according to a fourth evanescent field microscopy unit shown in FIG. 14.

The experiment is described as example 1. The example includes Imaging of aqueous solutions with T-8878 fluorophores from Molecular Probes on a feeding core structure.

The curve A shows a schematic drawing of the transverse intensity field distribution of the realized feeding core structure (example 1) with the refractive indices as follows:

n1=3.47, n2=n4=n6=1.34, n3=1.49, n5=0.13+3.30i and the geometry: a=f=∞, b=7.5 μm, c=49 nm, d=2 μm, e=8 nm. Physically n1 corresponds to a substrate, n2 and n4 to a CYTOP polymer layer, n3 to a PMMA polymer layer, n5 to a gold film layer and n6 to the sample under investigation. The symbols a, b, c, d, e and f represent the thickness of respectively the substrate, the lover cladding, feeding core upper cladding, metal film and sample under investigation.

The calculations are performed for 633 nm wavelength and TM polarized light.

The curves B and C shows the simultaneous fluorescence images of a first and a second confined eigenmodes, which fluorescence images was collected in example 1 with an objective lens [×20, Olympus, NA=0.40] using a microscope with barrier filter for the excitation wavelength 633 nm.

### EXAMPLES

### Example 1

The optical modes of a feeding core can be found as solutions to the eigenvalue equation, which can be derived from Maxwell's equations subject to the eigenvalue conditions imposed by the feeding core geometry. A confined electromagnetic wave and solution to the Maxwell's eigenvalue equation must be continuous at all interfaces of the structure and the field amplitude must be zero at infinity. Given the feeding geometry the eigenvalue conditions for the propagation constant βand intensity field distribution of all confined modes can be solved numerically. FIG. 14 shows an example of the intensity field distribution of a solution to a feeding core structure. The example shows two confined eigenmodes of the structure. A seen a significant part of the field of either mode is penetration into the buffer above the metal layer. It is this tail that interacts with fluorchromes in the substance under investigation. The two modes have slightly different propagation constants. Interference between the two modes in principle give rise to a periodic change in the distribution of the field between the lower feeding core and the upper plasmon guiding structure.

Due to ohmic loss in the metal the propagation length of the modes in the structure is limited. However, by changing the geometry of the feeding core structure it is possible to change the intensity field distribution between the metal film guide and dielectric guide. In particular, a feeding core structure with higher concentration of energy in the dielectric guide can allow the total power to propagate over a longer length scale if illumination of larger areas is desired. Further information relating to ohmic loss in relating to geometry can be found in T Tamir, F. Y. Kou, Optics Letters, 5, 367 (1987).

FIG. 13 shows experimental results obtained from a structure according to the design considered in FIG. 14.

The feeding core structure was covered with fluorescing molecules in an aqueous solution with a refractive index similar to the CYTOP polymer film. The confined modes of the feeding core structure was excited via end-fire coupling of 633 nm laser light by aligning a fiber to the facet of the high-index polymer film in the structure. Only in the areas with gold film LR-SPP/confined modes in the metallic film was excited and fluorescing molecules in the vicinity of the metal film was thereby excited. The fluorescence was collected using a microscope objective (X20, Olympus, NA=0.40).

### Example 2

In this example the SPP sub-unit is comprised of the following basic elements: A substrate which acts as support for the light guiding layers. At least one layer of lower dielectric cladding with refractive index n1. On top of the lower cladding layer(s) the unit further comprises a core layer of material characterized by a negative real part of its dielectric constant within the frequency range of interest. Finally the sub-unit comprises a mechanism for support of the substance under investigation.

In a preferred embodiment, the substrate is chosen to be comprised of a layer of BK7 glass with a refractive index of 1,517. In this embodiment, the lower cladding has refractive index n₁ essentially equal to the refractive index n₂ of the substance under investigation. In this preferred embodiment, the material is chosen to be a 4 μm layer of the fluoropolymer CYTOP with a refractive index of 1.34 which essentially matches the index of an aqueous substance. The core layer is comprised of a layer of metal, preferably Ag, deposited on top of the lower cladding structure. The thickness of the silver layer in this embodiment is 8 nm. The metal layer consists of a finite width stripe which, when covered with water, supports the propagation of a long range evanescent field microscopy (LR-SPP) along the stripe. The metal stripe is connected to a wider section of metal, the interaction region, where the LR-SPP is diverging to spread over a wider area while interaction with the fluorescent units under investigation.

The sub-unit in the first preferred embodiment can be realized using the following processing steps: Spin coat a layer of CYTOP on top a BK7 wafer. Cure the Cytop by heating. Spin coat layer of photoresist on top of the structure. Illuminate the resist with UV light through a mask with the desired metal pattern. Develop the resist. Metal deposition of Ag. Remove resist with metal on top in acetone.

### Other Examples

Another preferred embodiment comprises a structure similar to the one described in the first preferred embodiment with the difference that the region of interaction in the metal layer is connected with narrow metal guides on each side such as to provide a more homogenous distribution of power in the interaction region.

In a third preferred embodiment, the lower cladding on top of BK7 glass consists of three layers. The layers are arranged in such a way that n₁^{lower},n₁^{upper}<n₁^{middle} support propagation of light captured by the middle layer by total internal reflection. In this preferred embodiment this lower cladding waveguide is chosen to be single mode at 633 nm. In order to realize such a configuration suitable dimensions for the lower cladding layers are: All three lower cladding layers of a=4 μm thickness, n₁^{lower}=n₁^{upper} =1.340 and n₁^{middle}=1.341. With these dimensions the numerical frequency of the waveguide is V=2πa/λ((n₁^{middle})2−(n₁^{lower})2)½=2.06.

Since V<2.405, the slab waveguide has a single transverse mode only. On top of the lower cladding structure a thin LR-SPP core layer is applied to at least part of the surface. When in contact with the substance under investigation the core layer supports the propagation of plasmons with essentially the same propagation constant as the mode in the cladding waveguide. The thickness of the core layer is chosen to achieve significant overlap between the LR-SPP mode and the mode supported by cladding core.

In a fourth preferred embodiment, the lower cladding consists of three layers arranged in such a way as to provide a multimode waveguide of light guided within the middle layer. This can be achieved by increasing the thickness of the middle layer such as to e.g. 20 μm. Advantage of such a configuration compared with the one described in the third embodiment is a larger tolerance in aligning the sub unit to the generating light source. The disadvantage is a lower coupling efficient between the light in the guide and the LR-SPP.

In the third and the fourth preferred embodiment, the multilayer structures of the lower cladding are realized by spin coating of multiple layers on top of each other.

In a fifth preferred embodiment enclosing all previous four embodiments, the sub-unit in addition to the lower cladding layer(s) further comprises a thin top cladding layer deposited on top of the lower cladding and the core layers. The refractive index of the top cladding layer is substantially equal to the index of the lower cladding and in turn the substance under investigation. One purpose of the top cladding layer is to protect the guiding core. Another purpose is to limit the reach of the LR-SPP evanescent tail into the substance under investigation. A still further purpose of the top cladding could be to have LR-SPP guiding within the core in selected regions without applying the substance under investigation. A final purpose of the top cladding is to provide a support for the substance under investigation in the region of interaction. The top cladding can be made e.g. by spin coating.

In a sixth preferred embodiment enclosing all previous embodiments, the sub-unit is furthermore supplied with a support aggregate for the substance under investigation. The support frame in this preferred embodiment is realized as a combination top cladding with part of the cladding removed over the region of interaction and a support ring of silicone surrounding the area.

It should be mentioned that the preferred embodiments described above only cover a very limited number of embodiments within the gist of the present invention. There is a large freedom in choice of bottom substrate. Dimension and material choice of the lower cladding and core layers depend crucially on the wavelength of desire just as the choice of materials for the bottom cladding depends on the refractive index of the substance under investigation.

1. An evanescent field microscopy sub-unit for an examination system for examination of a specimen, said evanescent field microscopy sub-unit comprises a first dielectric cladding layer having an absolute refractive index nᵢ, and a core layer having a thickness tₘ, a width wm and a length lₘ coated onto at least a part of said first cladding layer, said evanescent field microscopy sub unit being arranged to support a specimen to form a part or all of a second cladding on the side of the core layer opposite the first cladding layer.

2. An evanescent field microscopy sub-unit according to claim 1 wherein said core layer is of a dielectric material having a refractive index which is significantly higher than that that of said first cladding layer.

3. An evanescent field microscopy sub-unit, in the form of a surface plasmon polarition sub-unit, said evanescent field microscopy sub-unit comprises a core layer having a thickness tₘ, a width wₘ and a length lₘ, said core layer being coated onto one of a) at least a part of a first dielectric cladding layer having an absolute refractive index nᵢ, and b) a support unit, such as a wafer, said surface plasmon polarition sub-unit being arranged to support a specimen to form a part or all of a second cladding on the side of the core layer opposite the first cladding layer or opposite the support unit.

4. An evanescent field microscopy sub-unit according to claim 3 wherein the core layer is of a material with a negative real part dielectric constant when excited by an electromagnetic wave at longer optical wavelength.

5. An evanescent field microscopy sub-unit according to claim 3 wherein the core layer is of a material having a negative real part dielectric constant when subjected to waves having a frequency of f₁, in the core material, wherein f₁ l is in the interval from 1.5*10¹⁴ Hz (2000 nm) to 1.5*10¹⁵ Hz (200 nm).

6. An evanescent field microscopy sub-unit according to claim 3 wherein the dielectric material of the cladding layer has a positive real part dielectric constant when subjected to waves having a frequency of f₂ in the core material, wherein f₂ is between 1,5*10¹⁴ Hz and 1,5*10¹⁵ Hz.

7. An evanescent field microscopy sub-unit according to claim 1 wherein the core layer is of a material selected from the group consisting of glass materials, polymer materials, semiconductor materials, gold, silver, copper, aluminum, platinum, nickel, chromium, cadmium, indium, titanium, lead, superconducting materials, mixtures thereof and alloys thereof.

8. An evanescent field microscopy surface plasmon polarition sub-unit according to claim 1 wherein the core layer has a thickness tₘ of up to about 100 nm.

9. An evanescent field microscopy sub-unit according to claim 1 wherein the core layer has a width wₘ of at least its thickness.

10. An evanescent field microscopy sub-unit according to claim 1 wherein the first dielectric cladding layer has an absolute refractive index n₁, of at least 1.20.

11. An evanescent field microscopy sub-unit according to claim 1 wherein the first dielectric cladding layer comprises two or more layered regions, each of said regions comprising absolute refractive indexes n_{i . . . x} of at least 1.20.

12. An evanescent field microscopy sub-unit according to claim 1 wherein the first cladding layer comprises or is of a cyclic fluoropolymer.

13. An evanescent field microscopy sub-unit according to claim 1 wherein the first dielectric cladding layer has a thickness of at least 1 nm.

14. An evanescent field microscopy sub-unit according to claim 1 further comprising at least one additional layer applied on the side of the first dielectric cladding layer turning away from the core layer, said at least one layer including a feeding core layer coupling with the core layer, for at least one wavelength.

15. An evanescent field microscopy sub-unit according to claim 14 wherein the at least one additional layer applied on the side of the first dielectric cladding layer turning away from the core layer further includes a third cladding layer, the feeding core layer being sandwiched between the first and the third claddings.

16. An evanescent field microscopy sub-unit according to claim 15 wherein the feeding core layer has a refractive index n₃ which is higher than n₁.

17. An evanescent field microscopy sub-unit according to claim 15 wherein the third cladding layer has a refractive index n₄ which is at least 1.20.

18. An evanescent field microscopy sub-unit according to claim 1 further comprising a light coupling unit for coupling light into the core optionally via a feeding core.

19. An evanescent field microscopy sub-unit according to claim 1 wherein the sub-unit is arranged to support a specimen to form at least a part of a second cladding on the side of the core layer opposite the first cladding layer, the sub-unit comprising a specimen support unit adapted to support the specimen to thereby bring the specimen into a distance of the core layer of 2 □m or less.

20. An evanescent field microscopy sub-unit according to claim 19 wherein the specimen support unit is in the form of at least one of a slide, a container, and a flow cell.

21. An evanescent field microscopy sub-unit according to claim 1 wherein the sub-unit is arranged to support a specimen to form at least a part of a second cladding on the side of the core layer opposite the first cladding layer, said sub-unit comprising a specimen cavity formed in the part of the second cladding layer, the specimen cavity being adapted to form a specimen support unit.

22. An evanescent field microscopy sub-unit according to claim 1 wherein the sub-unit comprises means for regulating the distance between the specimen support unit and the core.

23. An evanescent field microscopy sub-unit according to claim according to claim 1, said sub-unit being in the form of a chip comprising a core layer sandwiched between a first cladding layer and a second cladding layer, wherein the second cladding layer comprises an aperture to provide a cavity with a bottom provided by the core layer, wherein the first and the second cladding layer have essentially identical refractive indexes.

24. An evanescent field microscopy sub-unit according to claim 23 wherein the first cladding layer is spun unto a supporting substrate, and has a thickness of at least 1 μm, and the core layer has a thickness which is sufficient high for being a multimode core for at least one optical wavelength above 1 nm.

25. An evanescent field microscopy sub-unit according to claim 23 wherein the first and the second cladding layer have a refractive index of about 1.33, the core layer has a refractive index of at least 1.45.

26. An examination system for examination of a specimen, said system comprises an evanescent field microscopy sub unit and a light source and a detector unit, said evanescent field microscopy sub unit being as defined in claim 1.

27. An examination system for examination of a specimen, said system comprises an evanescent field microscopy sub-unit, a light source and a detector unit,
said sub-unit comprising a first dielectric cladding layer having an absolute refractive index n₁, and a core layer coated onto at least a part of said first cladding layer, said evanescent field microscopy sub-unit being arranged to support a specimen to form a part or all of a second cladding on the side of the core layer opposite the first cladding layer,
said light source being coupled to said surface plasmon polarition sub-unit for guiding light into said core, wherein said core has a thickness tₘ, selected so as to in combination with the light generate and propagate surface plasmons along core/cladding interfaces of a hypothetical surface plasmon polarition test unit differing from the surface plasmon polarition sub-unit in that it comprises a hypothetical second cladding layer identical with the first cladding layer on the side of the core layer opposite the first cladding layer,
said detector unit being adapted to collect a signal induced by light guided in said core.

28. An examination system for examination of a specimen according to claim 27 wherein the evanescent field microscopy sub-unit is a surface plasmon polarition sub-unit.

29. An examination system for examination of a specimen according to claim 27 wherein said evanescent field microscopy sub-unit in the form of a surface plasmon polarition sub-unit and said light source in combination are capable of generating and propagating surface plasmons along core/cladding interfaces of a hypothetical surface plasmon polarition test unit differing from the surface plasmon polarition sub-unit in that it comprises a hypothetical second cladding layer essentially identical with the first cladding layer on the side of the core layer opposite the first cladding layer, so as to in combination with the light source generate an evanescent plasmon polarition field in the hypothetical second cladding, wherein the evanescent plasmon polarition field preferably has an extension in the z direction into the hypothetical second cladding, which is at least 50 nm.

30. An evanescent field microscopy unit comprising a first and a second dielectric cladding layer sandwiching a core layer, said first cladding layer having an absolute refractive index n₁, said core layer being coated onto at least a part of said first cladding layer, and said second cladding layer comprising a specimen wherein said specimen comprises a substance to be investigated immersed in a support matrix having an absolute refractive index n₂, wherein n₁=A×n₂, where 0.95≦A≦1.05.

31. An examination system in combination with a specimen for examination of said specimen, said system comprising an evanescent field microscopy unit, a light source and a detection unit,
said evanescent field microscopy unit comprising a first and a second dielectric cladding layers sandwiching a core layer, said first cladding layer has an absolute refractive index n₁, said core layer being coated onto at least a part of said first cladding layer, and said second cladding layer comprising said specimen wherein said specimen comprises a substance to be investigated immersed in a support matrix having an absolute refractive index n₂, wherein n₁=A×n₂, where 0.2≦A≧1.2.
said light source being coupled to said evanescent field microscopy unit for guiding light into said core, wherein said core has a thickness tₘ, selected so as to in combination with the light source generate and propagate surface plasmons along said core/cladding interfaces and whereby an evanescent plasmon polarition field capable of interact with the substance are generated in the secondary cladding to thereby generate a signal,
said detection unit being adapted to collect said signal.

32. An examination system in combination with a specimen according to claim 31 wherein said evanescent field microscopy unit comprises a feeding core layer coupling with the core layer, the light source being coupled to said evanescent field microscopy unit for guiding light into said core layer via said feeding core layer.

33. An examination system in combination with a specimen according to claim 31 wherein said evanescent field microscopy generating unit and said light source in combination are capable of generating and propagating surface plasmons along said core/cladding interfaces and whereby an evanescent plasmon polarition field capable of interacting with the substance is generated in the secondary cladding to thereby generate a signal, wherein the evanescent plasmon polarition field preferably has an extension in the z direction into the hypothetical second cladding, which is at least 50 nm, such as at least 100 nm, such as at least 1 μm such as up to about 10 μm e.g. around 5 μm.

34. A microscope comprising an evanescent field microscopy sub-unit as defined in claim 1.
